(19) United States
(12) Patent Application Publication
(10) Pub. No.: US 2026/0312343 A1
(43) Pub. Date: Oct. 8, 2026

(54) ELECTRICAL CONNECTOR WITH TRANSPARENT REGIONS AND CORRESPONDING INSPECTION STATION

(71) Applicant: FORD GLOBAL TECHNOLOGIES, LLC, Dearborn, MI (US)

(72) Inventors: Stuart C. Salter, White Lake, MI (US); David Lloyd Nutt, Monroe, MI (US); Joel Allen Pittenger, Rochester Hills, MI (US); Scott Robert Lirette, Royal Oak, MI (US); Douglas Whiteman Smith, Farmington Hills, MI (US)

(21) Appl. No.: 19/169,597

(22) Filed: Apr. 3, 2025

(51) Int. Cl. H01R 13/717; G06T 7/00; H01R 13/04; H01R 13/10; H01R 13/187

(52) U.S. Cl. CPC H01R 13/7172; G06T 7/0002; H01R 13/04; H01R 13/10; H01R 13/187; G06T 2207/20084

(57) ABSTRACT

An electrical connector assembly includes a plug and socket, each with engagement arms, retainers, and light pipes enclosed within housings that have opposing light-transparent windows. When mated, the plug and socket align their light pipes to permit light transmission from a single source. An inspection station secures the connector using a clamp and optical sensors positioned to view internal regions through the windows. A light source illuminates the internal regions, and processors analyze sensor data to determine connection status.

### TECHNICAL FIELD

This disclosure relates to automotive electronic devices.

### BACKGROUND

Vehicles incorporate electronic systems that manage everything from propulsion to infotainment and driver assistance features. These systems include a network of electronic control units (ECUs), which serve as the computational backbone of various subsystems. Each ECU is responsible for specific tasks such as transmission management, braking, and climate control. These ECUs communicate with one another through data buses such as the Controller Area Network (CAN), Local Interconnect Network (LIN), or Ethernet, enabling real-time data exchange.

The electrical wiring in a vehicle serves as the circulatory system that distributes power and data signals between ECUs, sensors, actuators, and user interfaces. The wiring harness is designed to manage both power distribution and communication, incorporating multiple voltage levels depending on the system requirements. Standard 12V systems remain dominant for most vehicle functions, while 48V systems are increasingly used in hybrid and electric powertrains to support higher power loads. High-voltage systems, often exceeding 400V or even 800V in electric vehicles, are dedicated to propulsion and battery management. Wiring harnesses are routed throughout the vehicle. Shielding techniques, including braided or foil-wrapped conductors, are often used in high-frequency signal lines to prevent signal degradation caused by electromagnetic interference.

### SUMMARY

An electrical connector assembly includes a plug and a socket, each comprising engagement arms, retainers, and light pipes enclosed within housings that have opposing windows transparent to certain wavelengths of light, such as ultraviolet. The plug includes pins held by engagement arms and retainers within a plug housing, while the socket includes receptacles similarly secured within a socket housing. The plug and socket light pipes are aligned when mated to allow light transmission from a single light source through both components. The windows, flush with the housing surfaces and aligned with overlap regions of the engagement arms and retainers, enable optical inspection or signaling. The light pipes may be positioned between rows of pins or receptacles or adjacent to the housings, which may be composed of white resin for light reflectivity.

An electrical connector assembly inspection station includes a clamp and optical sensors designed to secure and inspect an electrical connector assembly with housings that have light-transmissive window regions. Positioned between the clamp and assembly, the sensors are arranged to view internal regions through these windows and may be in direct contact with them. A light source, including ultraviolet options, illuminates the internal regions or light pipes of the connector. The system may further include processors programmed to determine connection status based on sensor data, optionally using machine learning or artificial intelligence models.

An assembly includes an electrical connector with a housing that has regions transparent to ultraviolet light but opaque to visible light, and contains at least one light pipe. The connector may include male and female components, with the light pipe configured to transmit light across their interface when mated, enabling optical communication or inspection through the UV-transparent regions.

### BRIEF DESCRIPTION OF THE DRAWINGS

FIG. 1 is a side view, in cross-section, of an electrical connector prior to assembly.

FIG. 2 is a side view, in cross-section, of the electrical connector of FIG. 1 after assembly.

FIG. 3 is a side view, in cross-section, of the electrical connector of FIG. 2 within an optical inspection unit.

FIGS. 4A and 4B are plan and side views, respectively, of an assembled electrical connector.

### DETAILED DESCRIPTION

Detailed embodiments of the present disclosure are provided herein. These embodiments, however, are merely examples and may be implemented in various alternative forms. The figures are not necessarily drawn to scale, and certain features may be exaggerated or minimized to highlight specific details of particular components. Accordingly, the structural and functional details described should not be interpreted as limiting but rather as illustrative examples for guiding those skilled in the art in applying the principles described in different implementations.

Electrical connectors play a role in facilitating connections between wiring harnesses and electronic components. Connector housings are sometimes made from high-durability thermoplastics, while the internal terminals can be composed of high-conductivity metals such as copper or copper alloys with surface treatments like tin, silver, or gold plating to enhance corrosion resistance and electrical performance. Sealing mechanisms such as rubber gaskets or gel-filled cavities are incorporated into connectors used in certain compartments or undercarriage locations to prevent water ingress and dust contamination. Locking features, including secondary locking mechanisms and terminal position assurance elements, help prevent disengagement.

The proposed connector technology incorporates one or more transparent or translucent windows integrated into a connector shell for visual inspection of the internal components after the connector halves are mated. This is achieved, in some implementations, through a dual-shot molding process where clear sections, capable of transmitting visible or ultraviolet (UVA) light, are strategically placed within the connector housing. These clear windows allow for the real-time observation of terminal alignment, potential terminal pushouts, and proper engagement of the locking mechanism without the need for disassembly.

Example materials include optical-grade polymers such as acrylic (PMMA), polyethylene (PE), or other materials optimized for light transmission. In cases where UVA light is used, the selected material should exhibit transparency within the specific wavelength range while maintaining sufficient mechanical integrity. The connector shell itself may be manufactured from a white resin instead of the conventional gray to enhance internal light reflection and visibility through the clear sections. Additionally, optical-grade silicone can be used for seals and locking plugs to maintain transparency and flexibility.

To facilitate illumination within the connector, light pipes are integrated into locations, channeling visible or UVA light from an external source through the housing. These light pipes ensure that illumination reaches the inspection zones, eliminating shadows and enhancing contrast for visual or automated inspection. The light pipes can be positioned along the perimeter of the connector shell, with dedicated entry points at the connector ends where external light sources can be coupled. Light guides may be molded into the housing structure, running parallel to the rows of terminals for uniform distribution of light across the internal cavity.

Specific placements for light pipes can include:

Entry points at the connector interface: Light pipes can be positioned near the coupling interface of the connector, where an external illumination module can inject light into the pipes. These entry points can be designed with a reflective coating to maximize light capture.

Perimeter routing: Light pipes can be embedded along the outer shell, directing light towards the transparent windows while preventing direct glare into a camera system.

Terminal row integration: Light pipes can be designed to follow the internal layout of terminal rows, running in parallel to prevent obstruction while providing consistent lighting.

Locking mechanism illumination: A dedicated light pipe can direct light specifically towards the locking mechanism.

For inspection and validation, a camera system can be positioned to capture multiple angles of the internal components. The camera setup is mounted within a clamp that holds the connector in place for repeatable imaging. The inspection system can leverage, for example, artificial intelligence (AI) and machine learning (ML) algorithms to analyze the captured images, detecting misalignment, bent terminals, and improper locking engagement. By using UVA illumination and appropriate optical filters, the system can increase contrast and highlight potential defects that may not be as readily visible under standard lighting.

The terminal arrangement within the connector can be designed with visibility in mind so that key areas remain unobstructed when viewed through the clear windows. Internal components can be positioned to minimize occlusion and enable comprehensive inspection from multiple viewpoints. The two halves of the connector may be composed of contrasting materials, particularly in the locking region, to further differentiate engaged and disengaged states.

In one example, a connector assembly includes interrelated components arranged to facilitate both electrical interconnection and visual inspection of internal terminal engagement. The connector housing is an elongated, multi-part enclosure designed to receive and secure multiple electrical terminals in a fixed arrangement. A dual-shot molded clear window is positioned centrally along the longitudinal axis, allowing an external visual or optical inspection system to assess the integrity of the terminals after mating. The housing may be manufactured from a white resin material to enhance the reflection of internally introduced light.

The locking mechanism comprises a set of locking pins arranged within the connector housing to create a secure mechanical engagement between mating connector halves. These locking pins may be formed using a dual-shot molding process or shortened to allow light transmission through the structure. Their placement within the connector aligns with the terminal retention features, keeping the terminals fully engaged when the connector is locked.

Seals composed of optical-grade silicone are positioned at designated locations within the housing to provide environmental robustness while allowing light to pass through. These seals are molded in a way that maintains a tight interface between the mating halves while keeping the necessary optical clarity for inspection purposes. The flexible nature of optical-grade silicone allows the sealing elements to conform to the structural variations of the connector without obstructing visibility.

A light pipe extends into the back portion of the connector housing, forming an optical transmission path for light injection. This light pipe channels illumination from an external light source positioned at the rear of the connector. The length and curvature of the light pipe can be adapted to accommodate space constraints and facilitate the alignment between the light source and the internal transparent sections of the connector housing. The injected light propagates through the internal structure, reflecting off the white resin walls and illuminating the inspection areas visible through the clear window.

The internal terminal arrangement includes conductive elements held in place within the connector housing. Structural features align these terminals within designated channels to keep them in proper electrical contact upon mating with a corresponding connector half. The transparent window and guided light path allow an optical inspection system to detect terminal misalignment, push-out conditions, or improper engagement of the locking mechanism.

In the assembled configuration, light enters through the designated light pipe, propagates through the housing, and reflects off internal surfaces toward the clear viewing window. The transmitted illumination highlights the position of the terminals and locking components, making it possible to verify their alignment without requiring disassembly.

An inspection assembly, in some examples, includes a clamp, camera chips, and associated optical components arranged around the connector to facilitate multi-angle inspection of the internal terminal arrangement. The clamp structure is composed of two opposing sections positioned on either side of the connector, with each section extending around the periphery of the connector housing. The clamp is designed to secure the connector in a fixed orientation, preventing movement during inspection. The material selection for the clamp provides structural rigidity while allowing alignment of the integrated optical components. The internal surfaces of the clamp may incorporate recesses or contours shaped to match the outer geometry of the connector, providing a stable interface that holds the assembly without applying excessive force.

Camera chips are placed within the clamp structure, oriented to capture multiple views of the transparent sections of the connector. The camera chips are arranged at distinct positions along the longitudinal axis of the connector, with at least one positioned on the top side and one on the bottom side, as well as possible additional cameras on opposing lateral sides. This configuration allows the cameras to capture images from different angles to detect variations in terminal placement and any possible misalignment. Each camera chip is integrated with an optical module, which includes lenses designed to focus light passing through the transparent sections of the connector. The optics are selected based on focal length and field of view requirements to provide an accurate representation of the terminal alignment inside the housing.

The optical components associated with each camera include lenses that are mounted within housings and positioned to direct light toward the transparent sections of the connector. These lenses may incorporate coatings that reduce glare or enhance contrast, depending on the spectral properties of the light used for illumination. The positioning of the optical elements within the clamp aligns each camera’s line of sight with the regions of interest inside the connector. The optical pathway may also include filters designed to enhance the detection of specific wavelengths if ultraviolet or other non-visible light sources are used.

The entire clamp, camera, and optical assembly is arranged to maintain consistent positioning of all components relative to the connector. The rigid structure of the clamp stabilizes the cameras while allowing light transmission paths to remain unobstructed. The design allows each camera to acquire high-resolution images of the internal terminals from multiple perspectives so that the inspection system can detect any misalignment, improper engagement, or mechanical displacement within the connector assembly.

In some implementations, misalignment, improper engagement, or mechanical displacement in a connector assembly can be detected using ML or AI models that can analyze images, identify patterns, and classify structural issues. Convolutional neural networks (CNNs) are particularly suited for this task due to their ability to extract spatial hierarchies of features from images. A CNN trained on high-resolution images of correctly and incorrectly engaged connectors can differentiate between subtle positional variations in terminal alignment. The model processes input images through multiple layers, including convolutional layers that detect edges and textures, pooling layers that reduce dimensionality while preserving key features, and fully connected layers that make the final determination on whether the connector exhibits misalignment or displacement. By training the CNN with a diverse dataset containing variations in lighting, viewing angles, and potential defects, the model gains robustness in detecting inconsistencies across different samples.

Transformer-based vision models, such as Vision Transformers (ViTs), offer another approach by leveraging mechanisms to analyze relationships between different regions of an image. Unlike CNNs, which focus on local feature extraction, ViTs assess the entire image holistically, allowing them to detect subtle deviations that might not be apparent when examining only small portions of the image. This model partitions an image into patches, processes each patch through multi-head layers, and constructs an understanding of the global and local structural integrity of the connector. The ability of ViTs to process spatial dependencies across the entire image makes them well-suited for identifying not only terminal misalignment but also deformation in locking mechanisms or variations in the engagement of connector halves.

Issue detection techniques using unsupervised learning models can provide an additional layer of analysis, particularly when labeled data is limited. Autoencoders, a type of neural network designed for representation learning, can be trained on images of properly assembled connectors to create compressed feature representations. During inference, when an image of a potentially misaligned connector is passed through the trained autoencoder, reconstruction error provides an indication of whether the connector differs from the learned normal patterns. High reconstruction errors signal deviations, which may correspond to improper engagement or mechanical displacement. Similarly, generative adversarial networks (GANs) can be employed for issue detection by training a generator-discriminator pair, where the discriminator learns to differentiate between properly aligned and defective connectors based on subtle variations.

Traditional computer vision techniques augmented by ML models can also contribute to the detection process. Edge detection algorithms, such as Canny edge detection, combined with feature-based ML classifiers, such as support vector machines (SVMs) or random forests, can process grayscale images and extract geometric relationships between connector components. These methods can highlight misaligned terminals by analyzing contour variations or detecting gaps that indicate improper engagement. By feeding these extracted features into a classifier, a decision can be made regarding whether the connector assembly is properly aligned or if an intervention is required. The integration of classical computer vision with ML allows for interpretable decision-making while maintaining the adaptability of AI-driven approaches.

Reinforcement learning can be used in an active inspection system where an AI agent learns optimal strategies for positioning cameras and adjusting illumination conditions to maximize defect detection accuracy. By modeling the inspection process as a decision-making exercise, the reinforcement learning agent refines its approach through trial and error, selecting viewpoints and focal adjustments that enhance visibility of misalignment or displacement. This method is particularly useful in dynamic manufacturing environments where lighting and orientation conditions may vary between inspections.

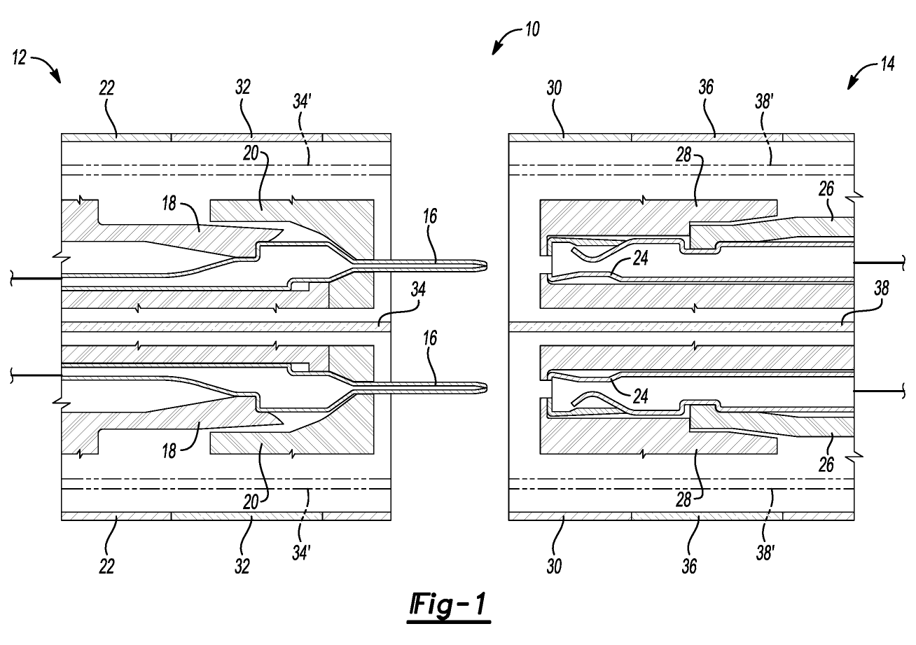

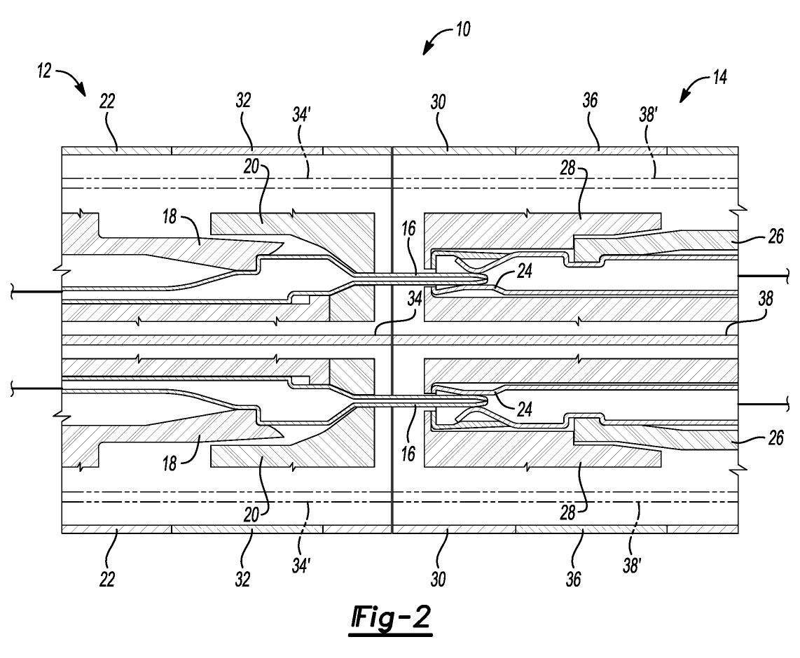

Referring to FIGS. 1 and 2, connector assembly 10 includes a male connector 12 and a female connector 14. The male connector 12 includes pins 16, engagement arms 18, and retainers 20, which are housed within a connector shell or housing 22. The pins 16 project through the retainers 20 and are retained in place by the engagement arms 18, which act as primary locking features, and by the retainers 20, which act as secondary locks or terminal position assurance (TPA) elements. During assembly, insertion of the pins 16 into their respective positions (left to right relative to the figures) deflects the engagement arms 18 outward until they snap over a shoulder or ledge formed on the pins, thereby securing them in place. The retainers 20 are subsequently inserted, blocking movement of the arms 18 and locking the pins 16 against back-out.

The female connector 14 includes mating receptacles 24, engagement arms 26, and retainers 28, all disposed within a housing 30. The receptacles 24 are likewise retained by a locking system including arms 26 and retainers 28. As receptacles 24 are inserted into the housing (right to left), the engagement arms 26 flex outward until they snap into corresponding detents on the receptacles 24, locking them in position. The retainers 28 then secure the arms 26 so the receptacles remain properly engaged.

Misalignment between the male and female connectors 12, 14 during mating—such as incomplete pin insertion, partial terminal engagement, or terminal back-out—can result in degraded electrical connection or signal loss. Additionally, engagement faults can occur between the locking arms 18, 26 and their corresponding retainers 20, 28, affecting the mechanical integrity of the connector assembly 10.

The housing 22 of the male connector 12 includes strategically placed inspection windows 32, formed from transparent or translucent material, such as optical-grade acrylic or polyethylene, and flush with adjacent surfaces. The windows 32 are produced via dual-shot molding, integrating clear material within the otherwise opaque shell. The windows 32 are aligned in opposing positions and are located to permit optical access to the overlap regions between the engagement arms 18 and retainers 20. This allows visual or automated inspection of terminal engagement, retention, and locking engagement—even after the male and female connectors 12, 14 are fully mated. A light pipe 34 is embedded along the housing 22 to direct light (e.g., visible or UVA wavelengths) to illuminate the internal components through the windows 32. The light pipe 34 may be coupled to an external light source and can have reflective coatings to maximize internal light transmission. Alternative placements for the light pipe 34 are illustrated in phantom.

Similarly, the housing 30 includes transparent windows 36 formed in a similar fashion and aligned to provide viewing access to the engagement interface between the engagement arms 26 and retainers 28. The female connector 14 also includes a light pipe 38 that runs through or adjacent to the housing 30 to uniformly illuminate the internal locking features. Like the male connector 12, the light pipe 38 can include reflective or refractive features to enhance visibility. These transparent regions and light guide paths are designed to facilitate both manual inspection and automated machine vision inspection.

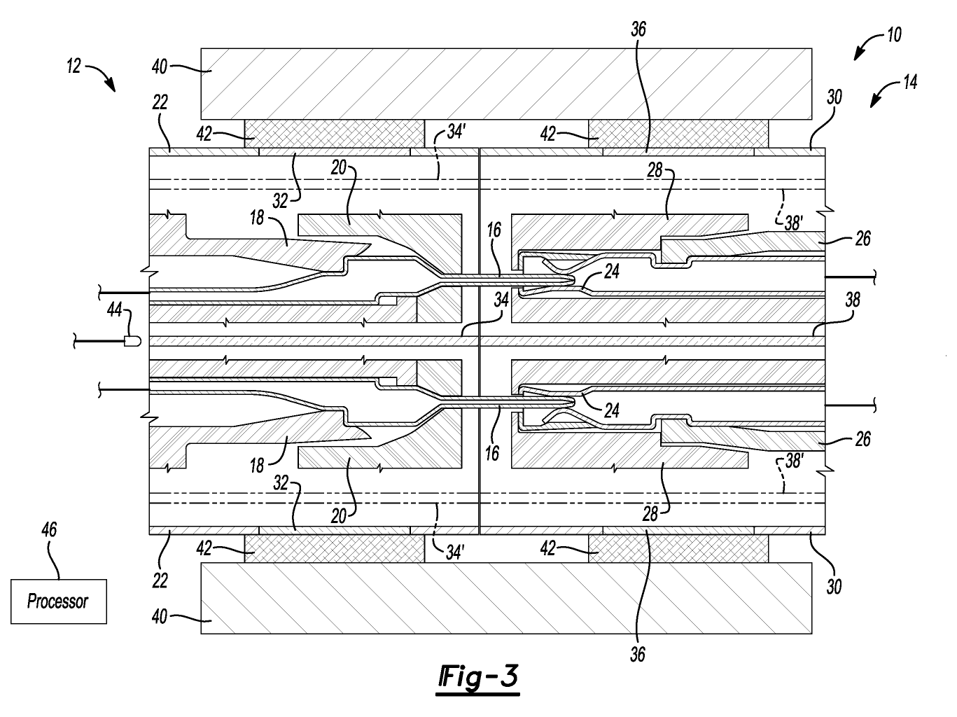

Referring to FIG. 3, an inspection station includes a fixture or clamp 40, a set of optical sensors 42 (e.g., camera modules), an external light source 44, and a processor 46. The clamp 40 holds the mated connector assembly 10 in a fixed and repeatable position. Optical sensors 42 are arranged at multiple angles—top, bottom, and lateral sides—to view the transparent windows 32, 36 from different perspectives. When activated, the light source 44 injects light into the light pipes 34, 38, flooding the connector interior with light and enhancing contrast at the inspection regions. The sensors 42 capture images or video data, which is sent to the processor 46.

The processor 46 may execute one or more computer vision algorithms or ML models designed to detect connector defects such as terminal misalignment, incomplete insertion, improper locking, or terminal push-out. These algorithms may include traditional image processing techniques, as well as supervised and unsupervised learning methods trained on large datasets of connector imagery.

The processor 46 may employ classical computer vision techniques such as Canny edge detection, Sobel filters, or Laplacian operators to extract geometric boundaries from the regions visible through the windows 32, 36. This preprocessing step facilitates downstream analysis by identifying the contours of the pins 16, receptacles 24, engagement arms 18, and retainers 28. Once edge maps are generated, the processor 46 may compare the resulting geometries to a stored reference model to detect structural deviations, such as terminal offset, tilt, or partial insertion depth. Contour-based shape descriptors (e.g., Hu moments) or histogram-based features (e.g., HOG) may further support classification tasks.

Extracted features (e.g., pixel intensities, geometric descriptors, local binary patterns) may be used to train ML models such as support vector machines (SVMs), random forests, or k-nearest neighbor (k-NN) classifiers. The models are trained on labeled datasets comprising images of properly assembled connectors and various conditions (e.g., terminal not fully inserted, lock not engaged, terminal rotated). Training may occur offline using a diverse dataset of connector assemblies captured under varying lighting conditions, orientations, and manufacturing tolerances. The trained classifier can then be deployed to the processor 46 for real-time inference in the inspection station.

In more advanced configurations, the processor 46 may use a CNN to automatically learn spatial hierarchies of visual features. A CNN-based model may include multiple convolutional and pooling layers, followed by fully connected layers that output a classification score indicating whether the connector assembly 10 is “OK” or exhibits a defect. CNN architectures such as ResNet, MobileNet, or EfficientNet may be selected based on the computational resources available at the inspection station. The model may be trained on thousands of labeled images of connector assemblies under controlled lighting, with ground truth labels indicating the presence or absence of specific types of mechanical or electrical faults.

As an alternative to CNNs, the processor 46 may use a transformer-based vision model that segments each image into patches and uses multi-head techniques to evaluate spatial relationships between features. ViTs are capable of detecting subtle and distributed issues across the connector assembly 10, such as small-scale shifts in the position of a terminal or progressive deformation of a locking mechanism.

In applications where labeled fault data is limited, unsupervised models such as autoencoders may be used to detect outliers. An autoencoder trained only on properly assembled connector images learns a compact latent representation of the normal appearance. When a defective image is passed through the autoencoder, high reconstruction error in specific regions (e.g., the locking zone) indicates a deviation from the norm. Similarly, a GAN-based approach may train a discriminator to distinguish real “OK” images from synthetically generated examples, learning to identify structural abnormalities without explicit defect labeling.

In some embodiments, the inspection station may incorporate an adaptive camera positioning system that uses reinforcement learning to dynamically optimize viewpoints, focus, and lighting. A policy network may be trained using trial-and-error interactions to maximize defect detection confidence, allowing the system to automatically reposition the optical sensors 42 based on the physical layout of the connector assembly 10 and real-time feedback from inspection results.

For robust algorithm performance, a comprehensive dataset is helpful. This dataset may include images of connectors with varying numbers and types of defects (e.g., terminal back-out, partial insertion, bent pins, misalignment), variations in lighting, angle, and housing translucency, and connector samples from multiple production batches to account for manufacturing tolerances.

Labeled datasets may be curated using manual annotation, semi-automated labeling tools, or digital twins simulating expected connector states. Data augmentation techniques, such as random rotation, scaling, or brightness adjustment, may be used to expand training data for generalization. The models can be validated using precision-recall curves, confusion matrices, or Intersection-over-Union (IoU) scores if bounding box localization is needed.

Once trained and validated, the models can be deployed in the embedded computing environment associated with the processor 46. Real-time inference may occur using optimized runtimes such as TensorRT or ONNX Runtime to provide deterministic performance in a high-throughput manufacturing line.

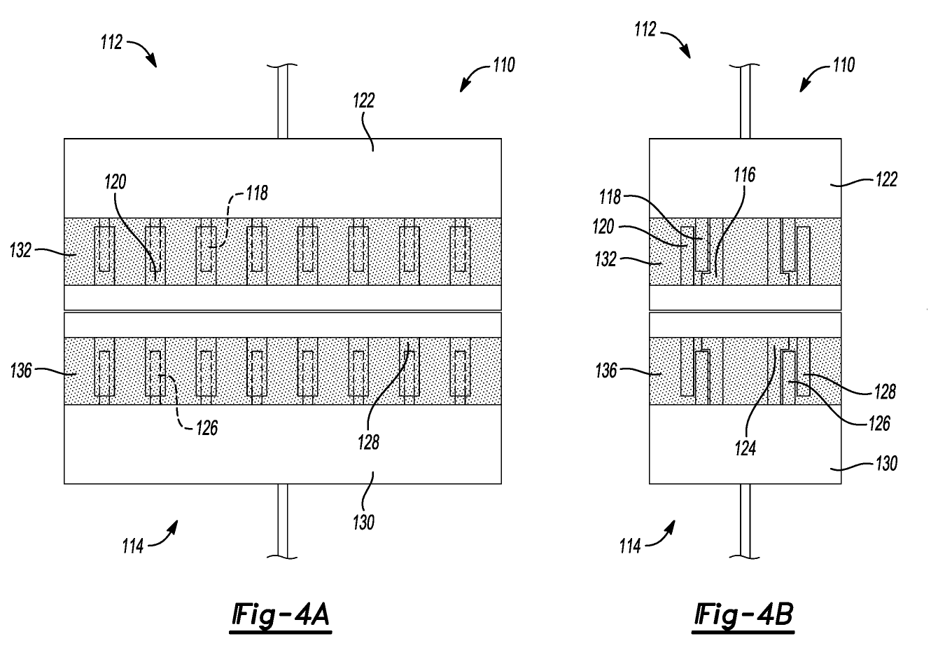

Referring to FIGS. 4A and 4B, another example connector assembly 110 is shown in top and side views, respectively. Male and female connectors 112 and 114 are similar in structure and function to those described above. The male connector 112 includes housing 122 with an inspection window 132 through which engagement arms 118 and retainers 120 are visible. The female connector 114 includes housing 130 with window 136, which permits viewing of engagement arms 126 and retainers 128. These connectors demonstrate the external visibility of retention features from different orientations, enabling multi-angle inspection and offering a pathway toward automated in-line inspection in a production environment.

The algorithms, methods, and processes described herein can be delivered to or implemented by a computer, controller, or processing device such as the processor 46, including dedicated or programmable ECUs. These algorithms, methods, and processes may be stored as data and executable instructions in various formats, such as information permanently stored on non-writable storage media (e.g., read-only memory devices) or alterably stored on writable storage media (e.g., compact discs, random access memory, or other magnetic and optical media). They can also be implemented as software executable objects. Alternatively, these algorithms, methods, and processes may be realized partially or entirely through hardware components such as application-specific integrated circuits (ASICs), field-programmable gate arrays (FPGAs), state machines, or other suitable hardware devices. In some cases, a combination of firmware, hardware, and software components may be used to implement these functionalities.

While example embodiments described above illustrate various implementations, they do not encompass all possible forms of the disclosed subject matter. The language used in this specification serves as a description rather than a limitation, and modifications may be made without departing from the scope and underlying principles of the disclosure. Furthermore, features from different embodiments may be combined to create additional variations.

What is claimed is:

1. An electrical connector assembly comprising:
a plug including pins, plug engagement arms configured to hold the pins in place, plug retainers configured to restrict movement of the plug engagement arms, a plug light pipe, and a plug housing surrounding at least the plug engagement arms and plug retainers and defining plug windows aligned on opposite sides of the plug housing that are transparent to at least some wavelengths of light; and
a socket including receptacles, socket engagement arms configured to hold the receptacles in place, socket retainers configured to restrict movement of the socket engagement arms, a socket light pipe, and a socket housing surrounding at least the socket engagement arms and socket retainers and defining socket windows aligned on opposite sides of the socket housing that are transparent to at least some wavelengths of light.

2. The electrical connector assembly of claim 1, wherein the plug light pipe and socket light pipe are positioned such that, when the plug and socket are mated, ends of the plug light pipe and socket light pipe are aligned to permit light from one of the plug light pipe or socket light pipe to pass to the other of the plug light pipe or socket light pipe such that a single light source can illuminate both the plug light pipe and socket light pipe.

3. The electrical connector assembly of claim 1, wherein plug windows and socket windows are transparent to ultraviolet light but not visible light.

4. The electrical connector assembly of claim 1, wherein the pins are arranged in rows and the plug light pipe is positioned between the rows.

5. The electrical connector assembly of claim 1, wherein the plug light pipe is positioned adjacent to the plug housing.

6. The electrical connector assembly of claim 1, wherein the plug windows are further aligned with overlap regions of the plug engagement arms and plug retainers.

7. The electrical connector assembly of claim 1, wherein the plug windows are flush with adjacent portions of the plug housing.

8. The electrical connector assembly of claim 1, wherein the receptacles are arranged in rows and the socket light pipe is positioned between the rows.

9. The electrical connector assembly of claim 1, wherein the socket light pipe is positioned adjacent to the socket housing.

10. The electrical connector assembly of claim 1, wherein the socket windows are further aligned with overlap regions of the socket engagement arms and socket retainers.

11. The electrical connector assembly of claim 1, wherein the socket windows are flush with adjacent portions of the socket housing.

12. The electrical connector assembly of claim 1, wherein the plug housing and socket housing include white resin.

13. An electrical connector assembly inspection station comprising:
a clamp and optical sensors configured to hold therein an electrical connector assembly that includes at least one housing defining window regions that are transparent to at least some wavelengths of light such that the optical sensors are between the clamp and the electrical connector assembly and are arranged to view regions internal to the electrical connector assembly via the window regions; and
a light source configured to illuminate the regions.

14. The electrical connector assembly inspection station of claim 13, wherein the clamp and optical sensors are further configured such that the optical sensors are in contact with the window regions.

15. The electrical connector assembly inspection station of claim 13 further comprising one or more processors programmed to identify a connection status of the electrical connector assembly based on data from the optical sensors.

16. The electrical connector assembly inspection station of claim 15, wherein the one or more processors are further programmed to implement a machine learning or artificial intelligence model to evaluate the data.

17. The electrical connector assembly inspection station of claim 13, wherein the light source is configured to illuminate a light pipe of the electrical connector assembly.

18. The electrical connector assembly inspection station of claim 13, wherein the light source is an ultraviolet light source.

19. An assembly comprising:
an electrical connector including a housing defining regions transparent to ultraviolet light but not visible light and carrying therein at least one light pipe.

20. The assembly of claim 19, wherein the electrical connector includes male and female connectors and wherein the at least one light pipe in configured to transmit light across an interface between the male and female connectors when mated.
